(19) United States
(12) Patent Application Publication
(10) Pub. No.: US 2007/0069867 A1
(43) Pub. Date: Mar. 29, 2007

(54) Stocking system and method for managing stocking

(76) Inventors: Elgar Fleisch, St. Gallen (CH); Christofer Hierold, Hombrechtikon (CH); Katharina Hildenbrand, Kilchberg (CH); Bernold Beckenbauer, Darmstadt (DE); Christian Metzger, Zurich (CH)

Correspondence Address: PAULEY PETERSEN & ERICKSON, 2800 WEST HIGGINS ROAD, SUITE 365, HOFFMAN ESTATES, IL, 60195, US

(21) Appl. No.: 10/592,413

(22) PCT Filed: Mar. 8, 2005
(86) PCT No.: PCT/EP05/02395

§ 371 Date: Dec. 8, 2006

(30) Foreign Application Priority Data
Mar. 11, 2004 (CH) 403/04

(51) Int. Cl. G08B 1/00

(52) U.S. Cl. 340/309.16

(57) ABSTRACT

A stocking system including at least one support for goods to be stocked, a communications network, and a computing unit for deriving inventory data. The stocking system has a gravimetric sensor element that, for detecting the goods, is in the form of a sensor array or sensor matrix. This sensor element can also be supplemented with an optical sensor element. By recording a multitude of measured values of the goods, the entire stocking system can be in the form of a sensor network and, with regard to the model, is configured for deriving inventory data whereby enabling both an identification of the type of the stocked goods as well as the determination of the quantity thereof.

### BACKGROUND OF THE INVENTION

1. Field of the Invention

This invention relates to a stocking system having at least one support, a modular detecting component, a method for managing stocking, and a computer program product.

2. Discussion of Related Art

Stocks, whose management and supply make high demands, are maintained in many economic areas, but in particular in commerce and the producing industry. On one hand, minimization of the stocked inventory and thus of the capital lockup and, on the other hand, quick availability of the goods that are to be stocked or that are already stocked, are among general demands.

In the retail business especially, the lack of availability or “out-of-stock” issue is among the currently biggest problems, apart from the formation of queues or lines in front of the check-out counter and theft. Thus, the customer stands before an empty shelf, he is not able to purchase the product he desires so that, in addition to missing out on the purchase, the customer becomes frustrated. Typically, however, the products are not sold out but are in the stockroom or in stocks at higher levels of hierarchy. Insufficient resupply of shelves is one of the most important causes for lack of availability.

In addition to physical transport and stock turnover, from a technical viewpoint, the detection and provision of the information about the current inventory and the expected changes in the sizes of the inventory pose a problem. The solutions of the state of the art are therefore based in part on the detection of changes in the form of measuring inflow and outflow, i.e. of flow quantities. One example for such a solution is the bar code reader of POS systems. This approach exhibits the usual flaws of incremental approaches such as, e.g., the susceptibility to error propagations or systematic errors, but also specific weaknesses such as faulty detection of removed goods, e.g. due to theft, or the lack of such detection. Furthermore, time delays in data detection are created because of the distance between the stock location and the detection point.

Solutions from the state of the art attempt a direct measurement of the inventory, and thus a detection of the inventory sizes. Because this must take place in a mostly automated and technically simple manner due to the typically very large number of stock points and goods, the complexity is limited. Weight measurement of the goods kept at one stock point is generally established.

European Patent Reference EP 1 333 257 A1 describes an arrangement for monitoring a filling level of individual containers in a stocking system. A container for the same type of articles has a sensor that triggers a filling measure when a weight-dependent threshold value is undershot.

PCT International Application WO 02/25230 teaches a shelf supporting parts or containers by a carrying structure whose load is measured by two load cells. By a suitable algebraic combination of the measurement results, it is allegedly possible to determine both the weight of the parts or containers as well as their position.

U.S. Pat. No. 4,419,734 shows a system for inventory control with a plurality of stock areas for one identical type of commodity, respectively, wherein the load of these stock areas and its change is detected. The inventory and its change can be derived for each inventory area.

European Patent Reference EP 0 063 354 describes a method and device for determining the quantity in supply of goods in a stock. Here, the respective total weight is measured for different places for depositing goods that are separated according to type. The number of units can be derived by division by the respective individual weight of the good.

A shelf with individual compartments for different goods is described in Japanese Patent Reference JP 10017121. A measurement of the weight of the stocked goods is carried out by strain gauges. The quantity of goods or their number of units is derived from the signal of the weight measurement by a computer and displayed.

One disadvantage of the solutions from the state of the art relates to the measures for combining the weight of a single good with a measurement of the weight of a plurality of such goods. Due to the specific properties of a good such as its size, the respective support or stocking location must be designed to be suitable for physical stocking. Thus, for the main part, standardized stock containers are combined with a weighing system so that the current number of units can be calculated from the total weight, given the individual weight. Such systems are not suited for the retail business, because the multitude of products and the necessary flexibility in positioning the commodities prohibits a sensible use of weighing systems with standard containers. In addition, such weighing systems are difficult to upgrade or cannot be configured freely because of the physical modifications required for the depositing and supporting areas that are firmly defined for individual types of products. In particular, compositions of groups of commodities that are topic-related and thus change often cannot be combined with an automatic inventory detection with solutions from the state of the art.

Furthermore, the solutions from the state of the art, both physically as well as logically/algorithmically, require an ex-ante-allocation of stock surface to good so that the supply of the stock surface, already, must take place in accordance with a plan that must be exactly followed.

In addition, the end customer behavior must also be considered, who demands an ergonomically favorable support of commodities on the one hand, but who can also produce errors, e.g. by false replacement of a good removed, resulting in different types of goods being deposited in one container.

Finally, the container-based solutions from the state of the art do not permit a determination of the position of goods beyond their allocation to a special stock container.

One complex approach that requires much technical effort includes designing the individual products so that they are uniquely identifiable. Chains of retail stores and manufacturers of consumer goods try to solve the problem by using RFID chips (radio frequency identification chips) by equipping shelves with RFID antennas so that products may be detected automatically. However, this approach requires an appropriate labeling of each product which meets problems in manufacturing or packaging, as well as difficulties relating to coordination within the supply chain. In addition, not every product can be equipped with a chip due to the physical and economic circumstances.

### SUMMARY OF THE INVENTION

One object of this invention is to improve the generic stocking systems.

Another object of this invention is to provide a stocking system that has an enhanced flexibility regarding the placement of goods to be stocked.

A further object is to provide a stocking system, which can be reconfigured, particularly with regard to the stocking of goods, which has a capability for the parallel identification of the type of good and quantity of good.

A further object is to provide a stocking system having a lower susceptibility to failure.

A further object is to provide a modular component suitable for use in a stocking system according to this invention, for upgrading stocking systems of the state of the art.

According to this invention, these objects are solved by aspects of this invention as described in this specification and in the claims.

This invention relates to a stocking system and a method for stocking management suitable therefor, wherein a plurality of sensors are allocated to the supports used for stocking, so that, by their cooperation, a detection of identity and number of units of the stocked products and/or goods is possible.

The system according to this invention clearly identifies individual stocking or shelf places on different hierarchy levels and measures their occupancy by a sensor that registers quantities that depend on number of units. The system maps a stocking system as a sensor network. Sensor data are collected on different hierarchy grades in real time and evaluated according to predefined or learned or static or variable rules so that a resupply can be controlled automatically. The data can not only be used internally within the branch, but also across the entire company, e.g. within the supply chain.

Identifying the good and measuring the number of units is either divided among different sensor units or solved by a single sensor unit, depending on the embodiment, with one at least one-dimensional arrangement of sensors in the form of a line or matrix always being applied. Here, a component is subsumed under sensor line or sensor matrix, which has an identical functionality, such as e.g. a line scanner. Because mechanically complex solutions are to be dispensed with for the logistical applications considered, static arrays are advantageous, without other solutions of the same functionality thus being excluded.

A detection and complete derivation of identification of the type of good and its number of units can be realized, according to this invention, by a gravimetric sensor element that can be supplemented by an optical sensor element, if necessary, or that can be used within the entire system. Here, the optical sensor element can be used as an independent additional component, or the optical functionality can be integrated into the gravimetric sensor element so that this also has an additional optical sensor technology. Thus, a logical and/or physical allocation of gravimetric and optical functionality is effected. The use of gravimetric and, if necessary, optical functionality permits a design that connects the identification of the commodities and, at the same time, the determination of their quantity. The particular properties of the gravimetric and optical detection can thus be combined in a single system in a particularly advantageous manner.

A matrix-like arrangement of weight sensors on which goods are stocked is an example for the integration of the functionalities of qualitative and quantitative detection in a single sensor element. Given a sufficiently good resolution, the shape of the bottom of the stocked goods can be deduced from the geometric arrangement of loaded sensors so that both their type as well as their quantity can be determined.

The requirements with regard to the resolution capability of the sensors are determined by the structure of the data detection and storage, in particular by their hierarchization. Thus it suffices to only be able to differentiate between a small number of shapes of bottom if the logical allocation of the support for the goods to be stored to a group of commodities is clearly determined. However, this can also be determined currently, e.g. by a shelf bearing a code structure that can be detected by an optical sensor. With this approach, the information that, for example, ten rectangular and contiguously arranged pressure sensors are loaded, can be used to identify a group of a total of twenty possible types of goods. The information that the support concerned contains goods of the commodity group of electronics then possibly permits a unique identification of the type as commercial container for batteries. The total weight measured by the ten sensors then permits a conclusion as to the number of batteries contained in the package.

In order to ensure a uniqueness of identification, information from additional sensors may be used and are able to recognize the color or stock temperature, for example. In principle, the required information can also be detected ex-ante or outside of the system, e.g., by clearly pre-defining that goods of a particular type are always stocked in the area of a subset of sensors. However, it is one advantage of this invention that flexible and software-based solutions become possible that make dynamic adjustments possible, exploiting all logical or algorithmic advantages of a multi-sensor network.

Optical systems, in particular, permit a good resolution and identification of commodities. Such an optical system can be realized, for example, by using CCD or CMOS cameras and image processing software that is known per se. In addition to the matrix-like arrangement of sensors in the camera types, pure linear arrays can be used as line-like cameras. In an image recorded by an optical sensor, individual goods can be identified, and their type as well as their quantity can thus be determined. The arrangement as sensor line or sensor matrix in this context means that there is an at least one or two-dimensional sequence of sensors, wherein the characteristics of and the distance between the sensors is determined by the technical design of the sensors and the support on which a detection is to be carried out or the goods stocked thereon.

This solution according to this invention has advantages if all goods are sufficiently visible and if they are safely identifiable under the selected circumstances and optical parameters. Use is limited when goods are stocked in rows or bundles in which only few objects are optically detectable. Problems occur also in the case of bulk materials or small parts that in turn are offered in packaging from which they are also sold. Rows of stocked cans or sweets in particular, such as chocolate candy bars, represent examples for such goods.

In such situations, an identification of the type of goods for only one sample of a set of commodities suffices, if their quantity can be determined otherwise. This identification can take place, e.g., by an optical sensor, and the determination of the quantity can take place by a weight sensor. According to this invention, identification and determination of quantity can be divided among two sensor elements or two functionalities of a single sensor element.

Allocations of supports to commodity groups, new types of goods and processing algorithms can only be changed easily and without physical change on the logical level due to the universality of the data detection.

The sensor data detected by a stocking system formed as a network can, for example, be modeled as a combinatorial problem from which a unique solution is derived that represents an occupancy of all supports with goods of a certain type and a certain quantity. For deriving these solutions, all data are combined on several levels and the space of the possible solutions is reduced by side conditions, such as a limited number of permissible shapes of bottoms. Known approaches and methods exist for solving basic combinatorial problems of this kind, the complexity of the solving algorithm and the number of sensors or the granularity of the data detection being in a complementary relation. Examples of suitable algorithms are genetic algorithms, including Tabu search or Simulated Annealing.

Advantageously, however, the ambiguity of the solutions is reduced by a suitable number and arrangement of sensors. Possibilities for such a design for multiple data detection by sensor lines or sensor matrices are, for example:

the integration of pressure sensors in a shelf at the side girders of a shelf board;

the integration of pressure sensors in a shelf board;

integration of pressure sensors in shelf panels that can be later mounted in shelves, e.g. by laying them on fixed shelf boards;

integration of tensile force sensors in a shelf for weight measurements in hanging shelves or on hooks;

integration of optically scanning or camera sensors in the shelf board located above the goods to be stocked;

integration of optically scanning or camera sensors in the shelf board located on the side of the shelf opposite to the goods to be stocked; and

integration of light-sensitive light-dark-sensors in the shelf board.

Combinations according to this invention of these embodiments as well as combinations with other sensor types, for example for measuring temperature or humidity, are advantageous.

The following may, for example, be used as sensors that are suitable according to this invention:

pressure sensors;

contact foils with a measurement of resistance or capacity;

pressure-sensitive surfaces (so-called touch pads);

magnetostrictive sensors;

acoustic wave sensors;

peizo-electric sensors;

CCD or CMOS cameras;

cameras with active illumination; and

light-dark sensors, e.g., with photodiodes.

Suitable embodiments for such sensors are state of the art.

The sensors or elements from a line-shaped or matrix-shaped arrangement of sensors are either coupled via cables or WLAN to an information system that evaluates the corresponding data with respect to the products located on a support. A target-oriented evaluation of this information is carried out in combination with the detection of the goods according to type and amount. If a minimum amount of a sort of product has been removed from the shelf, an automatic refill is thus prompted.

By an informatorial link-up of the stocking system to higher levels of a logistics system, tasks of location-wide and company-wide planning and coordination such as, e.g., a supply chain management, can be solved.

### BRIEF DESCRIPTION OF THE DRAWINGS

The stocking system according to this invention, modular detecting components and/or a method according to this invention are explained in more detail or elaborated upon in view of exemplary embodiments schematically represented in the drawing, wherein:

FIGS. 1a-b show schematic views of a support for goods to be stocked according to the state of the art compared to a support for goods to be stocked in a stocking system according to this invention;

FIG. 2 shows a schematic view of a support of a stocking system according to this invention, having a matrix-like arrangement of sensors;

FIG. 3 shows a schematic view of a support of a stocking system according to this invention having a first embodiment of an optical sensor;

FIG. 4 shows a schematic view of a support of a stocking system according to this invention having a second embodiment of an optical sensor;

FIG. 5 shows a schematic view of the informatorial system architecture of a stocking system according to this invention;

FIG. 6 shows a schematic view of three embodiments of modular detecting components according to this invention;

FIG. 7 shows a schematic view of the use of a first embodiment of a modular detecting component for upgrading a shelf;

FIG. 8 shows a schematic view of an embodiment of the combination according to this invention of the sensors;

FIGS. 9a-b show schematic views of examples for image processing for identification of goods or types of goods; and

FIG. 10 shows a schematic view of a support of a stocking system according to this invention with a third embodiment of an optical sensor with active illumination.

### DETAILED DESCRIPTION OF THE INVENTION

A stocking shelf 1 according to the state of the art having three different types of supports is described in FIG. 1a. Individual goods can be suspended from or containers can be placed on strut-shaped hooks 2a. Shelf boards 2b that are arranged one above the other serve the purpose of supporting products. Small parts of the same kind can be supported in fan-shaped boxes 2c. In the state of the art, simple weighing mechanisms that are connected with the respective boxes are used for such boxes in order to determine the amount of parts stocked therein.

FIG. 1b shows a stocking shelf 1′ modified in accordance with this invention, for use in a stocking system comprising a plurality of stocking surfaces. A sensor line comprising individual weight-sensitive sensors 3a is allocated to the supports for goods to be stocked as a gravimetric sensor element, so that the occupancy or load of the entire support used is detected in the form of a data acquisition at multiple points, and so that the stocking system can thus be modeled as a sensor network.

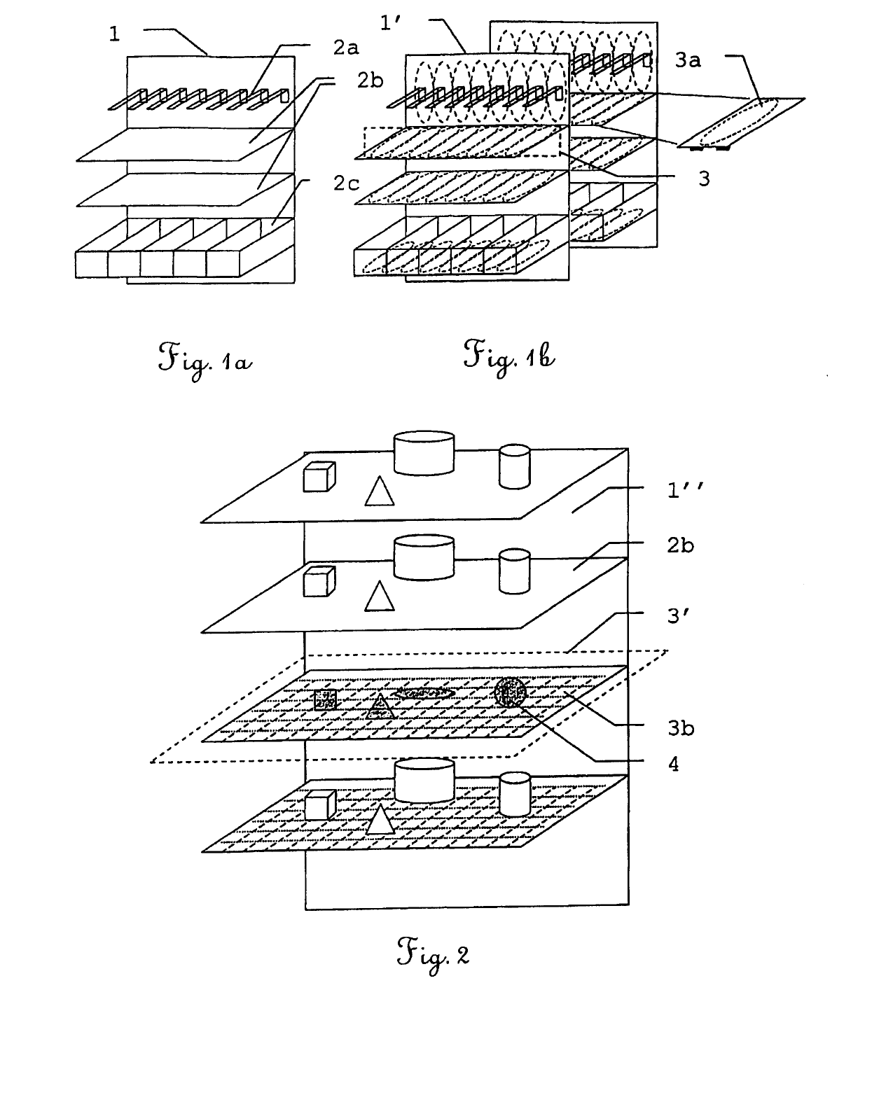

In FIG. 2, the embodiment of the support 2b of a shelf 1″ with an arrangement of sensors 3b in the form of a sensor matrix as a gravimetric sensor element 3′ is shown. Due to this plane arrangement, it is possible, given sufficient resolution, to determine the shape or surface 4 of the bottom of stocked goods. For example, weight sensors and/or light-dark-sensors can be used in the process. A conclusion as to the surface 4 of the bottom can be made from the form of the surface of contiguously loaded and/or darkened sensors. If the stocking system has the information which commodity group is stored in this shelf 1″, a comparatively simple resolution suffices to identify the type of goods. Depending on the type, the quantity can then be derived directly from this identification, e.g. in the case of large cans, bundles or beverage cases, or weight information must be drawn upon additionally, which, however, is at hand, anyway, if there is a matrix of pressure sensors.

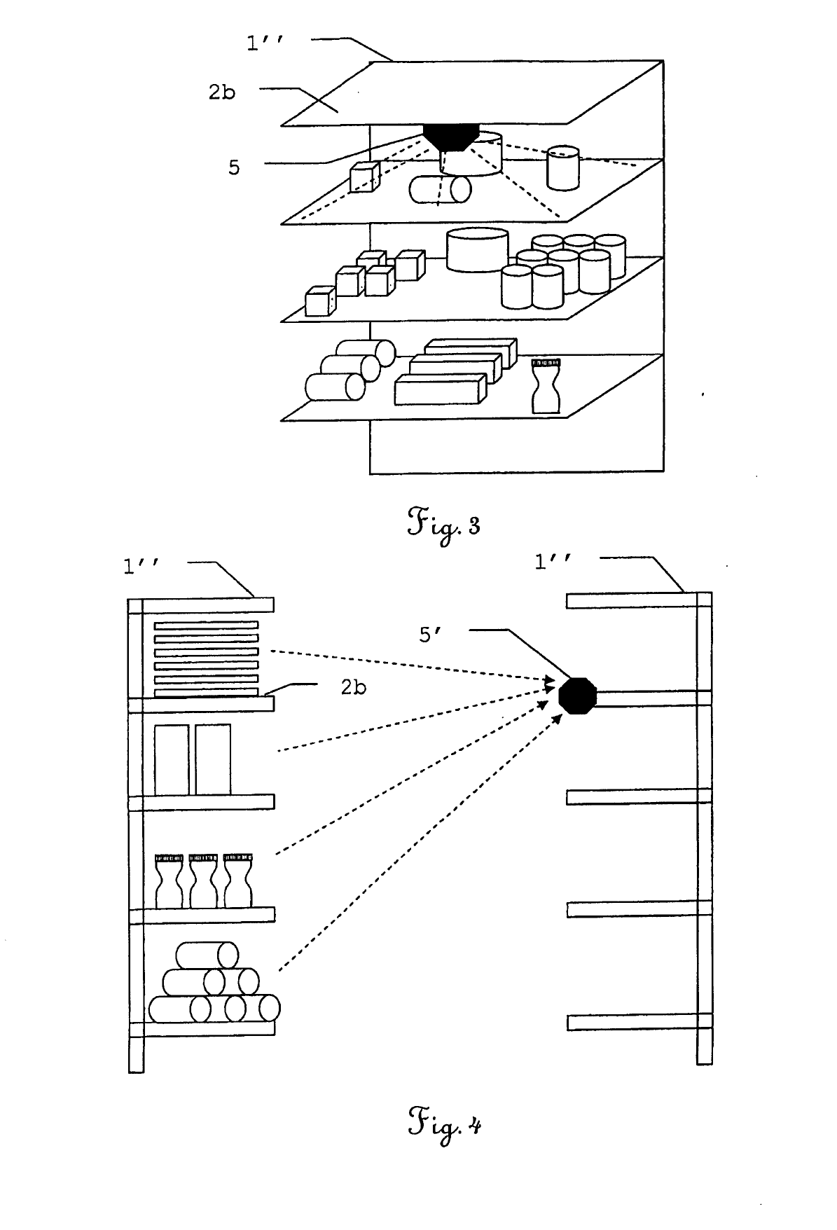

FIG. 3 shows the schematic representation of the support 2b of a stocking shelf 1″ with a first embodiment of an optical sensor element 5, wherein further sensor elements such as, e.g., the gravimetric sensor element are not shown for reasons of clarity. The optical sensor element 5 is mounted above a support 2b on the underside of a support 2b located above it. An identification and, if necessary, a detection of quantity, too, can take place by the optical detection of the goods stocked under it. If there is only a sparse occupancy of the support 2b, e.g. with jewelry or watches, the supports can be designed to be transparent so that, under favorable circumstances, a detection may be carried out on several supports 2b with a single optical sensor element 5. In other cases, a single optical sensor element 5 must be used for each support 2b, if necessary. The information detected by the optical sensor element 5 can now be combined with the results of further sensors or sensor arrangements. In particular, an optical sensor element 5 can also be allocated to several gravimetric sensor elements.

FIG. 4 shows the arrangement of two stocking shelves 1″ with supports 2b and a second embodiment of an optical sensor element 5′. The optical sensor element 5′ is mounted on a support 2b, which is placed in an optically advantageous manner, or on the stocking shelf 1″ opposite the stocking shelf 1″ on which a detection is to be carried out. Due to this mounting, a detection on a large range of supports 2b for goods to be stocked can be carried out with only a single optical sensor element 5′.

FIG. 5 shows the schematic representation of the informatorial system architecture of the stocking system according to this invention. The sensors 3a that are arranged line-like or matrix-like in a stocking shelf 1′″ are connected to the total system in the form of a sensor network via communication lines. Here, individual groups of stocking shelves or other storage units respectively form, logically and/or physically, hierarchical grades to which commodity groups, locations or legal or administrative affiliations, for example, are allocated. In this example, a multi-grade aggregation is carried out on the levels of the shelf A, of the shelf system B, of the branch C, of the company D and the supply chain E, wherein several entities or data connections of the next-lower hierarchy level of a communication network 6 respectively contribute to forming or constituting the current level. The total system has one or more computing units R for data processing, and the computing units can also be allocated to the various levels. The entire stocking system or its communicative integration into external systems furthermore has interfaces with in company or external employees 7 or information systems 8.

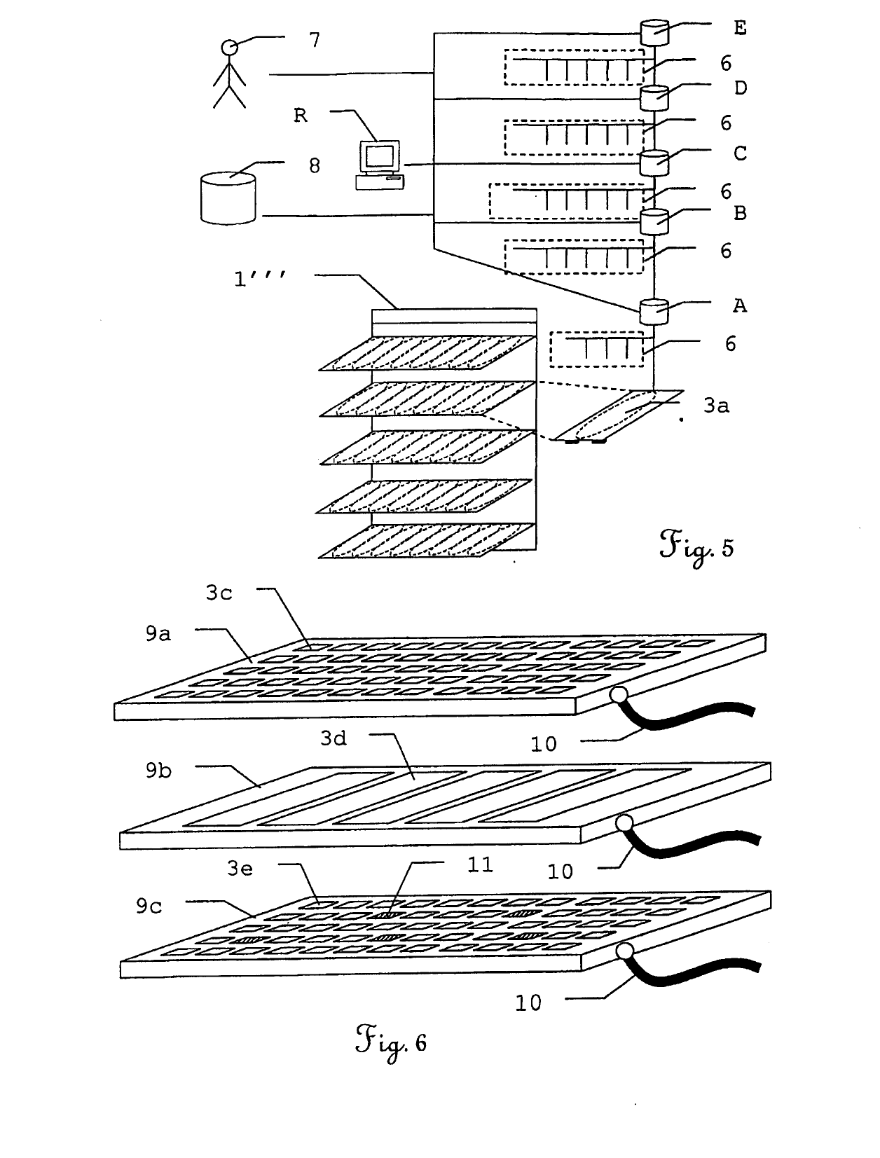

In FIG. 6, the schematic representation of three embodiments of modular detecting components according to this invention for upgrading existing shelves or support systems of the state of the art is shown. This detecting component is formed as a plane element, in particular, a rollable foil element, so that a positioning between a support and the goods to be stocked can take place. A connection to the stocking system takes place via a communication connection which here is formed as a cable 10, wireless connections also being suitable. The first modular detecting component 9a has a matrix-like arrangement of the same type of sensors 3c, e.g. pressure sensors, if necessary with an integrated optical functionality. Pressure and optical sensors can, for example, be arranged in two layers if the material of the pressure sensors is permeable for the selected spectral range of the optical sensors. Due to this plane arrangement of sensors, the entire stocking range or the entire stocking surface is completely covered or a detection can be carried out thereon. Given sufficiently fine granulation of the sensor surface and an electronic evaluation system that is thus adapted, this design permits the arbitrarily arranged stocking of different goods, so that a uniform equipment of, for example, shelf surfaces is possible that can be used flexibly and without effort regarding upgrading or adaptation. The second modular detecting component 9b has a linear arrangement of identical strip-shaped sensors 3d. Two different types of sensor are integrated into the third modular detecting component. The matrix of sensors 3e includes individually embedded further sensors 11 that are formed, for example, for detecting other kinds of parameters, such as, e.g., temperature. With such a detecting component, for example, in a chest freezer, temperature and quantity of a stocked good can be registered in parallel. In a humidor, for example, an addition of a further type of sensor permits the control of the temperature, humidity and number of cigars.

In FIG. 7, the schematic representation of the use of a first embodiment of the first modular detecting component 9a for upgrading a shelf is illustrated. In this shelf, the surfaces of the supports 2b are covered entirely with the first modular detecting component 9a so that different goods can be stocked there. In this example, the shapes of the bottoms can be derived by the number of contiguously loaded pressure sensors, and thus, the number of the cans 12 can be determined and the cans 12 can be told apart from the sales packaging 13 for small packages of ketchup. In addition, the number of small packages of ketchup still in the sales packaging 13 can be determined by the total weight of the sales packaging.

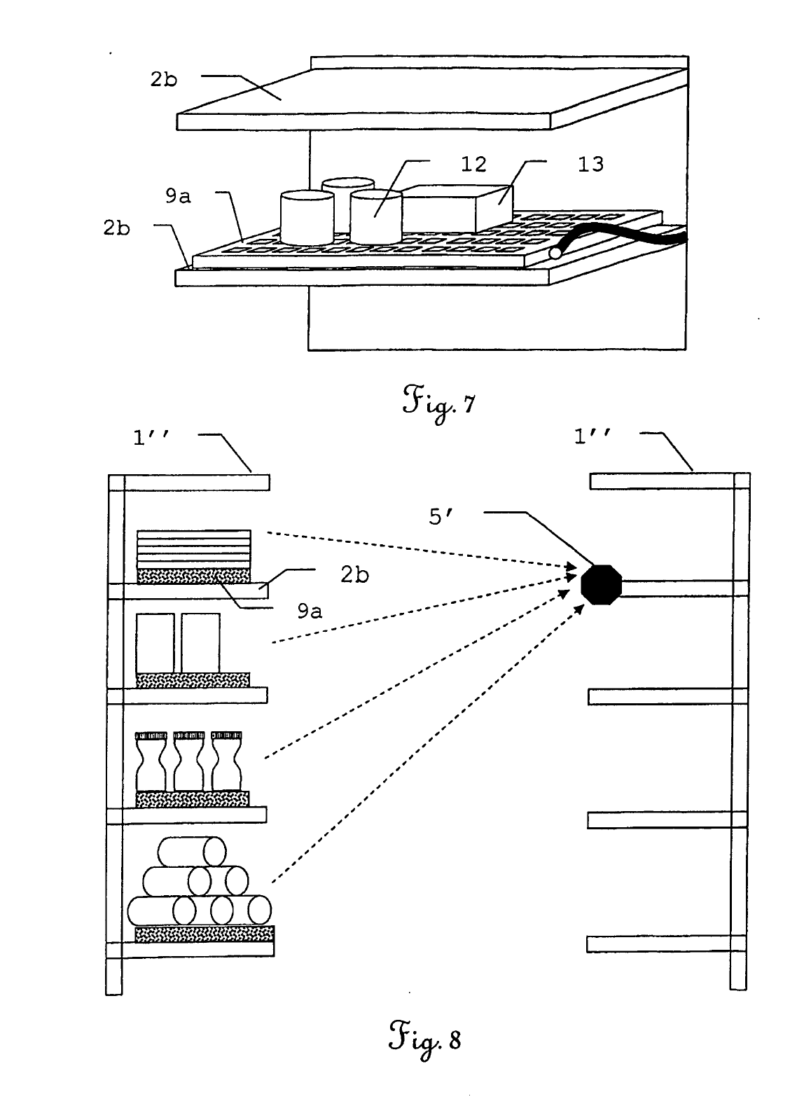

FIG. 8 shows the schematic representation of an embodiment for a combination of sensor types according to this invention. In one of the two opposing stocking shelves 1″, the goods to be stocked are placed on first modular detecting components 9a. Due to the insufficient differentiation of the shapes of the bottom assumed in this example, an optical sensor element 5′ is used, which is mounted on the inside of the opposite stocking shelf 1″. The identification of the stocked goods takes place by the optical sensor element 5′, their quantity, in contrast, being determined by the measured weight. An exclusive use of the purely optical sensor element 5′ in this example fails due to the dense stocking of the goods that cover each other.

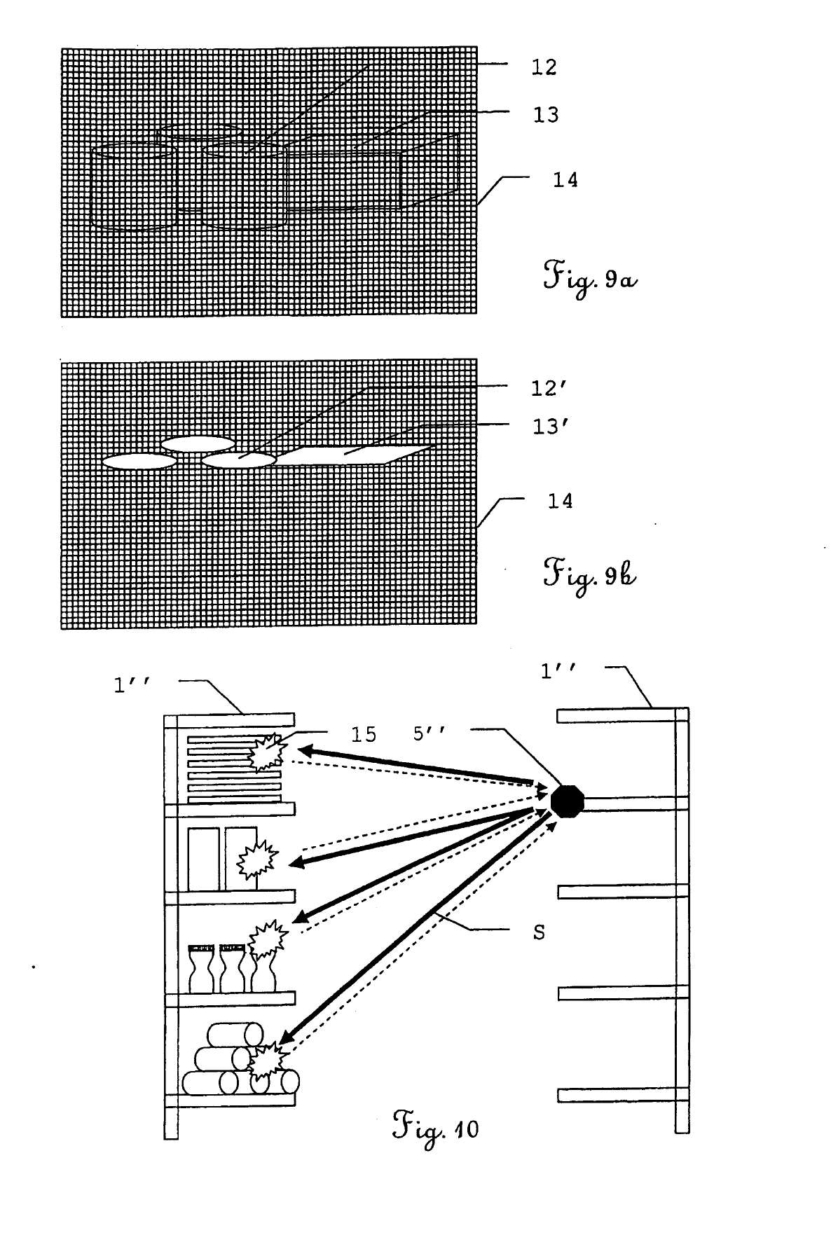

FIGS. 9a-b illustrate the schematic representation of examples for image processing for the identification of goods or types of goods. FIG. 9a schematically shows the detection of cans 12 stocked according to FIG. 7, and sales packagings 13 with the sensor matrix 14 of a CCD camera as an optical sensor element that can be integrated into a gravimetric sensor element, so that weight measurements and optical detection are possible in parallel. The detection of goods solely by a camera entails problems if it is to derive the exact quantity of the type of goods in addition to identifying it. Because of different angles and partial covering, an identification must be done by partial sections, if necessary, which takes time and is error-prone. Thus, according to this invention, the immediate detection by methods of image processing and gravimetric information is possible, optical sensor elements can also be integrated into the sensor network of a stocking system according to this invention, without any direct physical connection with gravimetric sensor elements.

A minor modification of the goods to be stocked facilitates identification by image processing. Thus, as shown by example in FIG. 9b, the highly reflective paint work on a part of the goods, in this case the lid of the cans 12′ and the sales packaging 13′, leads to a shape that can be distinguished well against the background, and which, in addition, can be designed to be uniquely identifiable. In contrast to more complex RFID chips, a simple label, which has further degrees of freedom due to its shape and color, suffices with most products in order to provide an enhanced identifiability. Because of the allocation of the supports to locations or commodity groups, the range of variation, and thus the number of different distinctive markings may remain limited.

FIG. 10 shows the connection of a marking 15 with an active optical sensor. The label shown in FIG. 9b requires a sensor that has a sufficient spectral resolution if the label is to be distinguished as to its color. Alternatively or additionally, the stocked goods can be illuminated. Thus, for example, the requirements with regard to the spectral resolution capability of the optical sensor element 5″ can be kept simple if an emission S takes place in a spectrally selective manner. For example, a monochromatic or narrow-band detector can be used in the sensor element 5″, with red and green markings 15 being illuminated at different times with red and green light. The two markings and thus, the goods correspondingly labeled, can be distinguished from the difference of intensities in the detected images.

In the figures, the embodiments of the stocking shelves and supports are to be understood purely as examples, as are the types of the stocked goods. This invention is to be transferred within the scope of acts by a person skilled in the art onto arbitrary stocking arrangements or systems based on the same problem. In the same way, the sensors mentioned are only examples for devices for the detection of suitable parameters that serve the purpose of identifying and measuring the quantity of the stocked goods.

1. A stocking system comprising:
at least one support (2a, 2b, 2c) for goods (12, 13) to be stocked, with an arrangement of several of the supports (2a, 2b, 2c) as shelf boards in a shelf system (1, 1′, 1″),
a communication network (6) for detecting and transmitting sensor signals,
a computing unit (R) for processing the sensor signals and for deriving inventory data, and
at least one gravimetric sensor element (3, 3′) for detecting the goods (12, 13) and formed as one of a sensor line and a sensor matrix allocated to the at least one support (2a, 2b, 2c).

2. The stocking system according to claim 1, wherein at least one optical sensor element (5, 5′, 5″) for optically detecting the goods (12, 13) and formed as one of a sensor line and a sensor matrix is allocated to the at least one support (2a, 2b, 2c), and the gravimetric sensor element (3, 3′) is formed as an optical sensor element.

3. The stocking system according to claim 2, wherein the gravimetric sensor element (3, 3′) is positionable between the support and the goods to be stocked.

4. The stocking system according to claim 3, wherein the gravimetric sensor element (3, 3′) is arranged so that the at least one support (2a, 2b, 2c) is one of detectable and coveredover an entire surface.

5. The stocking system according to claim 5, wherein at least one of the gravimetric sensor element (3, 3′) and the at least one optical sensor element (5, 5′, 5″) is formed and arranged so that every type of the goods (12, 13) to be stocked is detectable by at least two sensors of the sensor element (3, 3′, 5, 5′, 5″).

6. The stocking system according to claim 5, wherein the gravimetric sensor element (3, 3′, 5, 5′, 5″) is formed according to at least one of
a resistance measurement,
a capacity measurement,
an induction measurement,
a piezoelectric sensor,
a touch-sensitive surface,
a magnetostrictive sensor, and an
acoustic wave sensor.

7. The stocking system according to claim 6, wherein the optical sensor element (5, 5′, 5″) is formed as one of a CCD camera and a CMOS camera.

8. The stocking system according to claim 7, wherein the at least one optical sensor element (5, 5′, 5″) is formed with one of a spectral sensitivity and a spectral selectivity.

9. The stocking system according to claim 8, wherein the at least one optical sensor element (5″) is formed for emission and reception of electromagnetic radiation (S).

10. The stocking system according to claim 9, wherein at least one further parameter sensor (11) for detecting at least one of a good-related parameter and an environment-related parameter is allocated to the at least one support (2a, 2b, 2c).

11. The stocking system according to claim 10, wherein at least one identification sensor for detecting RFID chips is allocated to the at least one support (2a, 2b, 2c).

12. The stocking system according to claim 11, further comprising a modular detecting component (9a, 9b, 9c) having a plane element as a support component for the goods (12, 13) to be stocked, and the plane element having the at least one gravimetric sensor element (3, 3′).

13. The stocking system according to claim 12, wherein the plane element has at least one of a parameter sensor (11) and an identification sensor.

14. A method for a stocking administration in the stocking system according to claim 1, comprising:
recording the sensor signals of the gravimetric sensor element (3, 3′),
processing the sensor signals for deriving inventory data, and allocating the sensor signals of a subset of sensors of the gravimetric sensor element (3, 3′) to at least one type of the goods (12, 13) to be stocked, wherein the allocation takes place in spatial relation.

15. The method according to claim 14, wherein the allocating is combined with a recognition of one of a shape and a cross-sectional surface, of a surface (4) of a bottom, of the type of the goods (12, 13) to be stocked.

16. The method according to claim 15, wherein the allocating is carried out by the one of the shape and the cross-sectional surface of the surface (4) of the bottom, of the type of the goods (12, 13) to be stocked.

17. The method according to claim 16, wherein the sensor signals of the subset are combined with the sensor signal of at least one of a parameter sensor (11) and an identification sensor.

18. The method according to claim 17, wherein a quantity which is allocated to the subset, of the type of the goods (12, 13) to be stocked, is deduced from the sensor signals of the subset.

19. The method according to claim 14, wherein a computer program product with a programming code is one of stored on a machine-readable carrier and represented by an electromagnetic wave.

20. The method according to claim 14, wherein the allocating is carried out by the one of the shape and the cross-sectional surface of the surface (4) of the bottom, of the type of the goods (12, 13) to be stocked.

21. The method according to claim 14, wherein the sensor signals of the subset are combined with the sensor signal of at least one of a parameter sensor (11) and an identification sensor.

22. The method according to claim 18, wherein a quantity which is allocated to the subset, of the type of the goods (12, 13) to be stocked, is deduced from the sensor signals of the subset.

23. The stocking system according to claim 1, wherein the gravimetric sensor element (3, 3′) is positionable between the support and the goods to be stocked.

24. The stocking system according to claim 1, wherein the gravimetric sensor element (3, 3′) is arranged so that the at least one support (2a, 2b, 2c) is one of detectable and covered over an entire surface.

25. The stocking system according to claim 1, wherein at least one of the gravimetric sensor element (3, 3′) and the at least one optical sensor element (5, 5′, 5″) is formed and arranged so that every type of the goods (12, 13) to be stocked is detectable by at least two sensors of the sensor element (3, 3′, 5, 5′, 5″).

26. The stocking system according to claim 1, wherein the gravimetric sensor element (3, 3′, 5, 5′, 5″) is formed according to at least one of
a pressure measurement,
a resistance measurement,
a capacity measurement,
an induction measurement,
a piezoelectric sensor,
a touch-sensitive surface,
a magnetostrictive sensor, and an
acoustic wave sensor.

27. The stocking system according to claim 2, wherein the optical sensor element (5, 5′, 5″) is formed as one of a CCD camera and a CMOS camera.

28. The stocking system according to claim 2, wherein the at least one optical sensor element (5, 5′, 5″) is formed with one of a spectral sensitivity and a spectral selectivity.

29. The stocking system according to claim 2, wherein the at least one optical sensor element (5″) is formed for emission and reception of electromagnetic radiation (S).

30. The stocking system according to claim 1, wherein at least one further parameter sensor (11) for detecting at least one of a good-related parameter and an environment-related parameter is allocated to the at least one support (2a, 2b, 2c).

31. The stocking system according to claim 1, wherein at least one identification sensor for detecting RFID chips is allocated to the at least one support (2a, 2b, 2c).

32. The stocking system according to claim 1, further comprising a modular detecting component (9a, 9b, 9c) having a plane element as a support component for the goods (12, 13) to be stocked, and the plane element having the at least one gravimetric sensor element (3, 3′).

33. The method according to claim 14, wherein a quantity which is allocated to the subset, of the type of the goods (12, 13) to be stocked, is deduced from the sensor signals of the subset.
